(19) United States
(12) Patent Application Publication
(10) Pub. No.: US 2015/0256502 A1
(43) Pub. Date: Sep. 10, 2015

(54) METHOD AND SYSTEM FOR PROCESSING SOCIAL NETWORK INFORMATION

(71) Applicant: TENCENT TECHNOLOGY (SHENZHEN) COMPANY LIMITED, Shenzhen (CN)

(72) Inventors: Hongjie WU, Shenzhen (CN); Ming TIAN, Shenzhen (CN); Zhongwei LI, Shenzhen (CN)

(21) Appl. No.: 14/719,280

(22) Filed: May 21, 2015

Related U.S. Application Data
(63) Continuation of application No. PCT/CN2013/086568, filed on Nov. 5, 2013.

(30) Foreign Application Priority Data
Nov. 22, 2012 (CN) 201210478330.2

(51) Int. Cl. H04L 12/58

(52) U.S. Cl. CPC H04L 51/32; H04L 51/34

(57) ABSTRACT

Embodiments of the present invention disclose a method and system for processing social network information. The method includes: establishing a list of posted information for each user; adding received newly-posted information of a user to the list of posted information of the corresponding user; acquiring, after receiving an access request of a client, the list of associated users of a user designated in the access request; separately reading a predetermined amount of information from the list of posted information of each user in the list of associated users; and returning all the read information posted by the associated users to the client.

### CROSS REFERENCE TO RELATED APPLICATIONS

This application is a continuation of International Application No. PCT/CN2013/086568, filed on Nov. 5, 2013, which claims priority to Chinese Patent Application No. 201210478330.2, filed on Nov. 22, 2012, the contents of both of which applications are herein incorporated herein by reference in their entirety.

### FIELD OF THE TECHNOLOGY

The present disclosure relates to the technical field of data services and network communications, and in particular, to a method and system for processing social network information, which can provide a stable and high-concurrency mass data reading service for users.

### BACKGROUND OF THE DISCLOSURE

The development of computer applications and Internet technologies are accompanied with the emerging of various social networks. Microblog provides users with a new way of sharing and propagating messages on the Internet, and compared with propagation manners such as print media, traditional media and websites, microblog propagates messages fast, which is the most prominent feature thereof Microblog, in China, is a platform for sharing, propagating and acquiring information based on user relationships, where users can post information about what they think and what they do in brief text (usually less than 140 characters) by using various terminals, so as to implement instant information sharing.

On the platform of microblog, each user not only shares messages but also propagates messages, and each message can be quickly propagated through a relationship chain between users, where the message is propagated in an explosive spreading manner. The relationship chain is a relationship list formed based on some hobby, purpose or interest among people, and in a special scenario of microblog, the relationship chain mainly refers to a user set including people whom a user follows and people who follow the user. Besides, a message on microblog is also a kind of User Generated Content (UGC) data.

A user generally acquires information through a home page of the user on microblog, and the home page of the user includes messages posted by the user, information posted by people whom the user follows, information received by the user, and the like. Because data are generated by users, massive amounts of users generate massive amounts of data, which also causes a massive reading and writing amount. How to propagate and acquire the data quickly and provide a high-performance concurrent reading service is an inevitable issue in the technical field.

The architecture design of a solution in the existing technology is shown in FIG. 1, and according to an implementation manner thereof, this solution can be referred to as “push”.

In the push method, a message list is maintained for each user, and the user can read the message list to generate a home page message of the user.

In the push method, each new message generated by the user is processed according to the following steps:

(1) Add a new message posted by a user to a message list of the user.

(2) Pull a relationship chain list (which mainly is a follower list) of the user.

(3) Add the new message to a message list of each follower of the user.

In the push method, information acquired by the user is processed according to the following steps:

(1) Acquire a given quantity of messages from the message list of the user.

(2) Filter the messages according to a specific requirement and a query condition, and return a result.

The solution in the existing technology has the following drawbacks:

(1) The real-time performance is poor. Each time a user posts a new message, a follower list of the user needs to be traversed, and the new message needs to be added to a message list of each follower. When there are few followers, a performance bottleneck does not occur, and the real-time performance is desirable. However, when the quantity of followers of the user increases to a certain order of magnitude, if different followers still use the push manner to acquire a same message, time when the different followers acquire the message differs significantly, and the real-time performance of message propagation plummets as the quantity of followers in the relationship chain of the user increases.

(2) The efficiency is low. The push manner does not consider online statuses of users but performs write operations on all users, which is not an efficient manner because an offline user does not need real-time data write, and a large proportion of CPU and network bandwidth is used for operations of low price/performance ratios.

(3) The push manner has a high requirement on machines and networks, which directly leads to an increase in operation and maintenance costs.

(4) A machine error affects a wide range of services, and leas to poor service quality. When a fault occurs in a service process, messages for message lists of followers of an affected user are missing, and as a result, the service becomes unavailable.

### SUMMARY

Embodiments of the present invention provide a method and system for processing social network information, thereby providing a real-time information propagation service of high efficiency and good user experience, and also reducing operation and maintenance costs. The technical solution is as follows:

A method for processing social network information, including:

establishing a list of posted information for each user;

adding received newly-posted information of a user to the list of posted information of the corresponding user;

acquiring, after receiving an access request of a client, a list of associated users of a user designated in the access request;

separately reading a predetermined amount of information from the list of posted information of each user in the list of associated users; and returning all the read information posted by the associated users to the client.

A system for processing social network information, including: an establishing module, configured to establish a list of posted information for each user;

a writing module, configured to add received newly-posted information of a user to the list of posted information of the corresponding user;

an acquiring module, configured to acquire, after receiving an access request of a client, a list of associated users of a user designated in the access request;

a reading module, configured to separately read a predetermined amount of information from the list of posted information of each user in the list of associated users; and

a returning module, configured to return all the read information posted by the associated users to the client.

The technical solution provided by the embodiments of the present invention brings the following beneficial effects: the method and system for processing social network information provided by the embodiments of the present invention use a “pull” manner, where each user maintains a list of posted information to save information posted by the user, and a user aggregates information posted by users in a list of associated users thereof and information posted by the user, to form home page information of the user, so that a real-time information propagation service of high efficiency and good experience can be provided for the user, and moreover, operation and maintenance costs are reduced.

### BRIEF DESCRIPTION OF THE DRAWINGS

To describe the technical solutions of the embodiments of the present invention more clearly, the following briefly introduces the accompanying drawings required for describing the embodiments. Apparently, the accompanying drawings in the following description show only some embodiments of the present invention, and a person of ordinary skill in the art may still derive other drawings from these accompanying drawings without creative efforts.

FIG. 1 is a flowchart of an existing technology for processing information on Microblog;

FIG. 2 is flowchart of a method for processing social network information provided by an embodiment of the present invention;

FIG. 3 is a flowchart of an example of information processing when the method of FIG. 2 is applied to a Microblog scenario; and

FIG. 4 is a structural diagram of a system for processing social network information provided by an embodiment of the present invention.

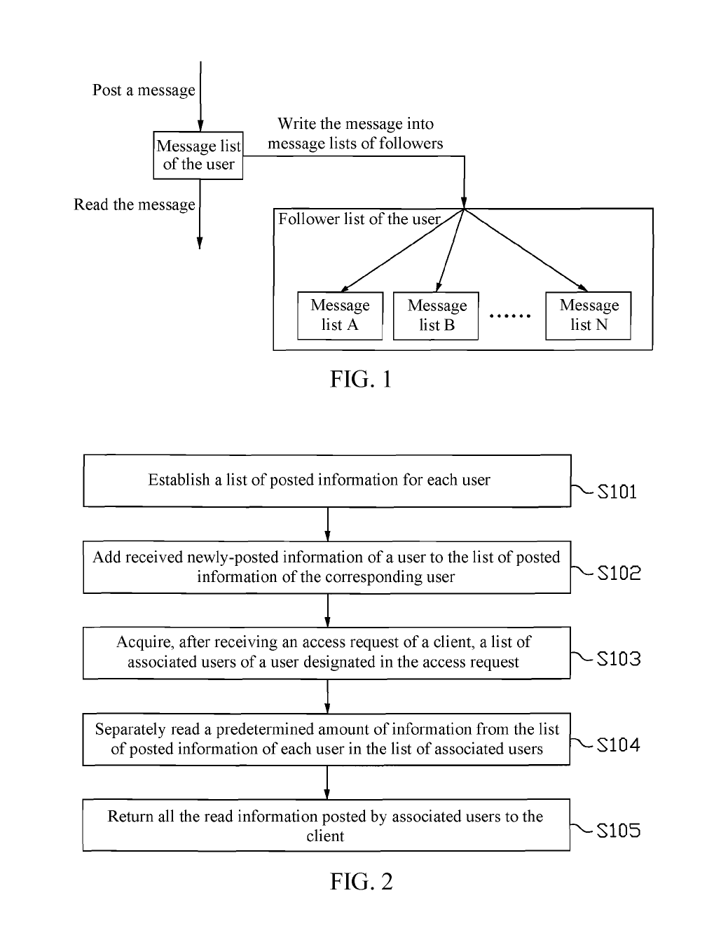

### DESCRIPTION OF EMBODIMENTS

Embodiments of the present invention provide a method and system for processing social network information. To make objectives, technical solutions and advantages of the present disclosure more clear, the implementation manners of the present disclosure are further described with reference to the accompanying drawings in the following.

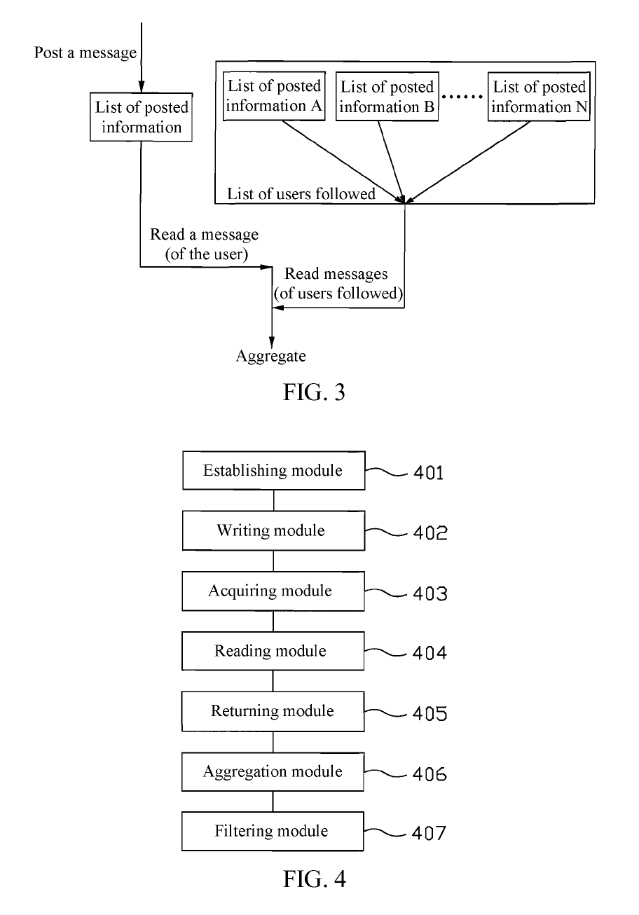

FIG. 2 is flowchart of a method for processing social network information provided by an embodiment of the present invention; and FIG. 3 is a flowchart of an example of information processing when the method for processing social network information of FIG. 2 is applied to a microblog scenario. Referring to FIG. 2 and FIG. 3, the method includes:

Step S101: Establish a list of posted information for each user.

Specifically, a server that provides an information processing function for a social network establishes the list of posted information for each user.

Step S102: Add received newly-posted information of a user to the list of posted information of the corresponding user.

Specifically, the user posts new information by using a client, and after receiving the information newly posted by the user, the server directly adds the newly-posted information to the list of posted information of the user.

Step S103: Acquire, after receiving an access request of a client, a list of associated users of a user designated in the access request.

When the user uses the social network, to facilitate information sharing with people whom the user follows, the user usually maintains a list of associated users, and puts people whom the user follows into the list of associated users, and a new person whom the user follows can be added to the list of associated users at any time, or a person whom the user no longer follows can be deleted from the list of associated users.

Specifically, when the user visits the social network by using the client, the client sends an access request to the server. After receiving the access request of the client, the server acquires the list of associated users of the user designated in the access request. For example, in an application scenario of microblog, the list of associated users refers to a user set that includes people whom the user follows (that is, a list of users followed).

Step S104: Separately read a predetermined amount of information from the list of posted information of each user in the list of associated users.

Specifically, using the application scenario of microblog as an example, when the user visits microblog through the client, the server separately reads a predetermined amount of information from the list of posted information of each person whom the user follows.

Step S105: Return all the read information posted by the associated users to the client.

Specifically, using the application scenario of microblog as an example, after reading the information from the list of posted information of each person whom the user follows, the server returns all the read information posted by the persons whom the user follows to the client of the user.

Further, after receiving the access request of the client, the method further includes: reading a predetermined amount of information from the list of posted information of the user designated in the access request and returning the read information to the client. Specifically, using the application scenario of microblog as an example, after receiving the access request of the client of the user, the server reads a predetermined amount of information from the list of posted information of the user and returns the read information to the client of the user.

Further, the method includes: performing an aggregation and sorting operation on the read information that is posted by the associated users and the read information that is posted by the user designated in the access request before returning the information to the client. Specifically, using the application scenario of microblog as an example, before the server returns the read information that is posted by each person whom the user follows and the read information that is posted by the user to the client, the server further aggregates the information and performs the sorting operation, for example, the server aggregates the information according to an inverted sequence of time when the information is posted, and returns the information to the client.

Further, the aggregated and sorted information is filtered before being returned to the client, so as to filter out some information content that the user does not want to see. Specifically, the user may set a filtering condition in advance, and the server filters, according to the filtering condition set by the user, the aggregated and sorted information, so that returned content does not contain information content that the user does not want to see.

The method for processing social network information provided by the foregoing embodiment does not use a “push” manner; instead, each user maintains a list of posted information to save information posted by the user. For example, using the application scenario of microblog as an example, a user of a client can aggregate the list of posted information of persons whom the user follows and the list of posted information of the user, to form home page information of the user. This manner is called a “pull” manner.

Referring to FIG. 4, FIG. 4 is a structural diagram of a system for processing social network information provided by an embodiment of the present invention, and the system includes:

an establishing module 401, configured to establish a list of posted information for each user;

a writing module 402, configured to add received newly-posted information of a user to the list of posted information of the corresponding user;

an acquiring module 403, configured to acquire, after receiving an access request of a client, a list of associated users of a user designated in the access request;

a reading module 404, configured to separately read a predetermined amount of information from the list of posted information of each user in the list of associated users; and

a returning module 405, configured to return all the read information posted by the associated users to the client.

Further, the reading module 404 is further configured to read a predetermined amount of information from the list of posted information of the user designated in the access request and return the read information to the client after receiving the access request of the client.

Further, the system further includes: an aggregation module 406, configured to perform an aggregating and sorting operation on the read information that is posted by the associated users and the information that is posted by the user designated in the access request.

Further, the system further includes: a filtering module 407, configured to filter the aggregated and sorted information.

Further, the list of associated users is a list of users whom the user designated in the access request follows.

For further details of the system for processing social network information of this embodiment, reference may be made to related descriptions of the method for processing social network information shown in FIG. 2 and FIG. 3.

The method and system for processing social network information provided by the foregoing embodiments use an implementing method of aggregation and pulling in the case of massive amounts of information, which has at least the following advantages:

(1) The method and system are simple, where the write operation is performed only once.

(2) The real-time performance is desirable; a user can share information quickly, and can also acquire latest information quickly. A flexible processing manner can be used to solve the problem of an oversized user following list, while it is ensured that data is not missing.

(3) The efficiency is high, no invalid operation is generated, and the consumption of CPU and network bandwidth relies on the quantity of online users, which ensures a high price/performance ratio.

(4) The operation and maintenance costs are low, and the scalability is desirable. When the processing performance of a machine declines, a machine can be added to provide support in a distributed manner.

(5) A machine error only affects a small range of services, and the service quality is high. When a service process is interrupted, because the “pull” manner is used, there is no write operation, and therefore, differences of data are not affected, and computation for acquiring information can be processed by a standby machine.

It should be noted that the terms “include”, “comprise”, and any variants thereof are intended to cover a non-exclusive inclusion. Therefore, in the context of a process, method, object, or device that includes a series of elements, the process, method, object, or device not only includes such elements, but also includes other elements not specified expressly, or may include inherent elements of the process, method, object, or device. Unless otherwise specified, an element limited by “include a/an . . . ” does not exclude other same elements existing in the process, the method, the article, or the device that includes the element.

A person of ordinary skill in the art may understand that all or some of the steps of the foregoing embodiments may be implemented by a computer program instructing relevant hardware. The program may be stored in a computer readable storage medium. The storage medium may be stored in a computer readable storage medium. When the program is being executed, steps of the foregoing method embodiments can be included. The storage medium may be a magnetic disk, an optical disc, a read-only memory (ROM) or a random access memory (RAM).

The above descriptions are merely preferred embodiments of the present invention, and are not intended to limit the present disclosure. Any modification, equivalent replacement, or improvement made within the spirit and principle of the present disclosure shall fall within the protection scope of the present disclosure.

What is claimed is:

1. A method for processing social network information, comprising:
establishing a list of posted information for each user;
adding received newly-posted information of a user to the list of posted information of the corresponding user;
acquiring, after receiving an access request of a client, a list of associated users of a user designated in the access request;
separately reading a predetermined amount of information from the list of posted information of each user in the list of associated users; and
returning all the read information posted by the associated users to the client.

2. The method for processing social network information according to claim 1, after receiving the access request of the client, further comprising:
reading a predetermined amount of information from the list of posted information of the user designated in the access request and returning the read information to the client.

3. The method for processing social network information according to claim 2, further comprising: performing an aggregation and sorting operation on the read information that is posted by the associated users and the read information that is posted by the user designated in the access request before returning the read information to the client.

4. The method for processing social network information according to claim 3, wherein the performing an aggregation and sorting operation on the read information that is posted by the associated users and the read information that is posted by the user designated in the access request comprises: aggregating the information according to an inverted sequence of time when the information is posted.

5. The method for processing social network information according to claim 3, further comprising: filtering the aggregated and sorted information before returning the information to the client.

6. The method for processing social network information according to claim 1, wherein the list of associated users is a list of users whom the user designated in the access request follows.

7. A system for processing social network information, comprising:
an establishing module, configured to establish a list of posted information for each user;
a writing module, configured to add received newly-posted information of a user to the list of posted information of the corresponding user;
an acquiring module, configured to acquire, after receiving an access request of a client, a list of associated users of a user designated in the access request;
a reading module, configured to separately read a predetermined amount of information from the list of posted information of each user in the list of associated users; and
a returning module, configured to return all the read information posted by the associated users to the client.

8. The system for processing social network information according to claim 7, wherein the reading module is further configured to read a predetermined amount of information from the list of posted information of the user designated in the access request and return the read information to the client.

9. The system for processing social network information according to claim 8, wherein the system further comprises:
an aggregation module, configured to perform an aggregation and sorting operation on the read information that is posted by the associated users and the read information that is posted by the user designated in the access request.

10. The system for processing social network information according to claim 9, wherein the aggregation module performs, according to an inverted sequence of time when the information is posted, the aggregation and sorting operation on the read information that is posted by the associated users and the read information that is posted by the user designated in the access request.

11. The system for processing social network information according to claim 9, wherein the system further comprises:
a filtering module, configured to filter the aggregated and sorted information.

12. The system for processing social network information according to claim 7, wherein the list of associated users is a list of users whom the user designated in the access request follows.
